(19) United States
(12) Patent Application Publication
(10) Pub. No.: US 2020/0365106 A1
(43) Pub. Date: Nov. 19, 2020

(54) BOOTSTRAP CAPACITOR OF GATE DRIVER ON ARRAY CIRCUIT, GATE DRIVER ON ARRAY CIRCUIT AND DISPLAY PANEL

(71) Applicant: SHENZHEN CHINA STAR OPTOELECTRONICS SEMICONDUCTOR DISPLAY TECHNOLOGY CO., LTD, Shenzhen, Guangdong (CN)

(72) Inventors: Suping XI, Shenzhen, Guangdong (CN); Tianhong WANG, Shenzhen, Guangdong (CN)

(21) Appl. No.: 16/097,635

(22) PCT Filed: Aug. 1, 2018
(86) PCT No.: PCT/CN2018/098113

§ 371 Date: Oct. 30, 2018

(30) Foreign Application Priority Data
Jun. 6, 2018 (CN) 201810572176.2

(51) Int. Cl. G09G 3/36; G02F 1/133

(52) U.S. Cl. CPC G09G 3/3677; G02F 1/13306

(57) ABSTRACT

Disclosed is a bootstrap capacitor of a gate driver on array (GOA) circuit, comprising: a first branch capacitor; and a second branch capacitor, located above the first branch capacitor, wherein the second branch capacitor is connected in parallel with the first branch capacitor, and a projection of the second branch capacitor at least partially overlaps a projection of the first branch capacitor in a horizontal plane to reduce a width of the bootstrap capacitor. Further disclosed are a GOA circuit and a display panel. There is an advantage of reducing a width occupied by a bootstrap capacitor.

### CROSS REFERENCE

This application claims the priority of Chinese Patent Application No. 2018105721762, entitled “Bootstrap capacitor of gate driver on array circuit, gate driver on array circuit and display panel”, filed on Jun. 6, 2018, of which is incorporated hereby incorporated in its entirety by reference.

### FIELD OF THE INVENTION

The present invention relates to a display field, and more particularly to a bootstrap capacitor of a gate driver on array circuit, a gate driver on array circuit and a display panel.

### BACKGROUND OF THE INVENTION

The liquid crystal display panel has become a display panel of a mobile communication device, a PC, a TV and etc. because of the advantages of high display quality, low price and convenient mobility. At present, the liquid crystal display panel driving technology gradually tends to adopt a gate driver on array (GOA) circuit, and the GOA circuit can simplify the manufacturing process of the flat display panel and eliminate the bonding process in the horizontal scanning line direction, thereby improving the productivity, reducing the product cost, and improving the integration of the display panel to be more suitable for making narrow frame or frameless display products to meet the visual pursuit of modern people.

The GOA circuit, i.e., the Gate Driver on Array technology, is a driving method in which the gate driving circuit is formed on the substrate by using the array process of the existing liquid crystal display panel to realize the progressive scanning of the scanning lines. The GOA circuit includes a plurality of thin film transistors, and the plurality of thin film transistors form a pull-up control circuit, a pull-up circuit, a pull-down holding circuit, a pull-down circuit and a stage transfer circuit, and generally for the function and stability of the GOA circuit, a bootstrap capacitor (C Boost) is designed, and a capacitance of the bootstrap capacitor needs to have a certain size to function stably. The calculation formula of the capacitance C is as follows:

$$C = \frac{ɛ S}{4 K π d} ;$$

wherein ε is the dielectric constant of the medium between the electrode plates, and S is the facing area of the two electrode plates, and d is the distance between the two electrode plates, and k is the electrostatic force constant.

Referring to FIG. 1(a) and FIG. 1(b), the parameters in FIG. 1(a) and FIG. 1(b) are substituted to obtain the capacitor of the bootstrap capacitor of the prior art:

$${C}_{present} = \frac{ɛ 0 L 0 W 0}{4 K π d 0} ;$$

As shown in the foregoing formula, the bootstrap capacitor needs to occupy a large width W0 on the substrate of the display panel, which is disadvantageous for the achievement of the narrow frame of the display panel with the GOA circuit.

### SUMMARY OF THE INVENTION

An objective of the present invention is to provide a bootstrap capacitor of a gate driver on array circuit, a gate driver on array circuit and a display panel for reducing a width occupied by a bootstrap capacitor.

For solving the aforesaid technical issue, the present invention first provides a bootstrap capacitor of a gate driver on array (GOA) circuit, comprising:

a first branch capacitor; and

a second branch capacitor, located above the first branch capacitor, wherein the second branch capacitor is connected in parallel with the first branch capacitor, and a projection of the second branch capacitor at least partially overlaps a projection of the first branch capacitor in a horizontal plane to reduce a width of the bootstrap capacitor.

In one embodiment of the present invention, the projection of the second branch capacitor in the horizontal plane is less than or equal to the projection of the first branch capacitor in the horizontal plane, and the projection of the second branch capacitor in the horizontal plane falls completely within a range of the projection of the first branch capacitor in the horizontal plane.

In one embodiment of the present invention, the first branch capacitor comprises a first electrode plate and a second electrode plate, and the second branch capacitor comprises the second electrode plate and a third electrode plate, and a projection of the first electrode plate on the second electrode plate at least partially overlaps a projection of the third electrode plate on the second electrode plate.

In one embodiment of the present invention, lengths and widths of the first electrode plate, the second electrode plate and the third electrode plate are all equal, and the first electrode plate, the second electrode plate and the third electrode plate are completely disposed opposite to one another.

In one embodiment of the present invention, a distance between the first electrode plate and the second electrode plate is d1, and a length of an overlapping region of the first electrode plate and the second electrode plate is L1, and a dielectric constant of the first branch capacitor is ε1, and a distance between the third electrode plate and the second electrode plate is d2, and a length of an overlapping region of the third electrode plate and the second electrode plate is L2, and a dielectric constant of the second branch capacitor is ε2, and then:

$$\frac{ɛ 1 L 1}{d 1} \leq \frac{ɛ 2 L 2}{d 2} .$$

In one embodiment of the present invention, the bootstrap capacitor further comprises a connection electrode, wherein the connection electrode is electrically connected to the first electrode plate and the third electrode plate, respectively, to achieve a parallel connection of the first branch capacitor and the second branch capacitor.

In one embodiment of the present invention, an overlapping portion of the projection of the third electrode plate on the second electrode plate and the projection of the first electrode plate on the second electrode plate is connected to the connection electrode, and a via hole is disposed on the second electrode plate, and the connection electrode is electrically connected to the first electrode plate and the third electrode plate through the via hole.

In one embodiment of the present invention, a gate insulating layer is disposed between the first electrode plate and the second electrode plate, and a second insulating layer is disposed between the second electrode plate and the third electrode plate.

Second, the embodiment of the present invention provides a GOA circuit, comprising the aforesaid bootstrap capacitor of the GOA circuit.

Third, the embodiment of the present invention provides a display panel comprising the aforesaid GOA circuit.

With implementing the embodiments of the present invention, the benefits are: the bootstrap capacitor comprises: a first branch capacitor and a second branch capacitor, located above the first branch capacitor, wherein the second branch capacitor is connected in parallel with the first branch capacitor, and a projection of the second branch capacitor at least partially overlaps a projection of the first branch capacitor in a horizontal plane to reduce a width of the bootstrap capacitor. With such arrangement, a width of the bootstrap capacitor can be reduced, which is advantageous for the achievement of the narrow frame of the display panel with the GOA circuit.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1(a) is a cross-sectional diagram of a bootstrap capacitor of a GOA circuit according to the prior art;

FIG. 1(b) is a top view diagram of a bootstrap capacitor of a GOA circuit according to the prior art;

FIG. 2(a) is a cross-sectional diagram of a bootstrap capacitor of a GOA circuit according to the first embodiment of the present invention;

FIG. 2(b) is a top view diagram of a bootstrap capacitor of a GOA circuit according to the first embodiment of the present invention;

FIG. 3(a) is a cross-sectional diagram of a bootstrap capacitor of a GOA circuit according to the second embodiment of the present invention;

FIG. 3(b) is a top view diagram of a bootstrap capacitor of a GOA circuit according to the second embodiment of the present invention;

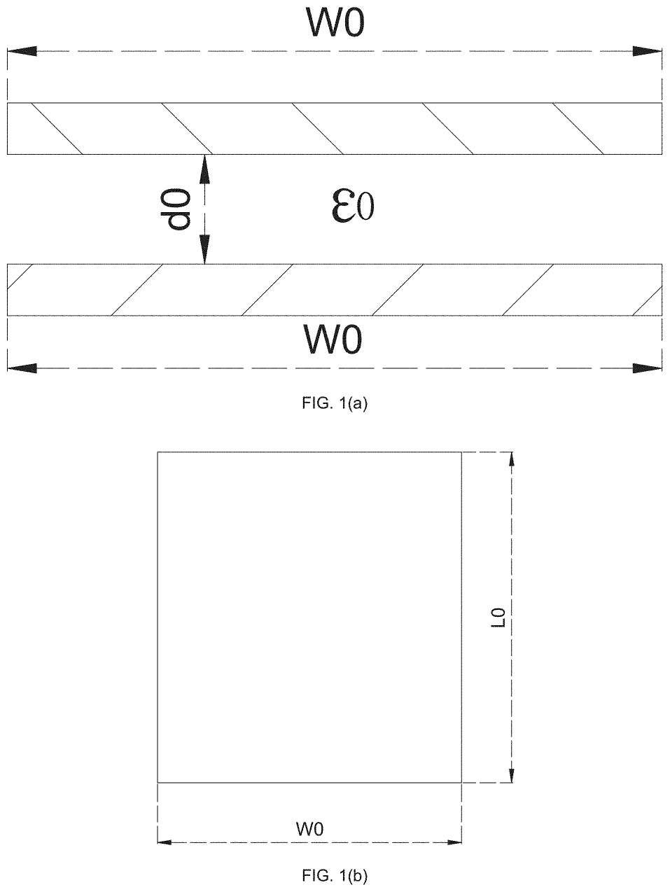

### DIAGRAM LABEL

210, 310—first electrode plate; 220, 320—second electrode plate; 221, 321—via hole; 230, 330—third electrode plate; 231, 331—connection electrode; C1, C11—first branch capacitor; and C2, C21—second branch capacitor.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

Furthermore, the terms “including” and “having” and their any deformations are intended to cover non-exclusive inclusion. For example, a process, a method, a system, a product or a device comprising a series of steps or units which is not limited to the steps or units already listed, but optionally further comprises steps or units which are not listed, or optionally further comprises other steps or units which are inherent in these the process, the method, the product or the device. The terminologies “first”, “second” and “third” are used for distinguishing different objects but not for describing the specific sequence.

### The First Embodiment

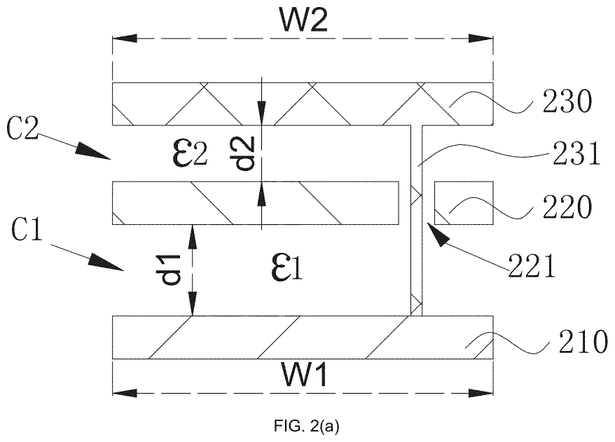

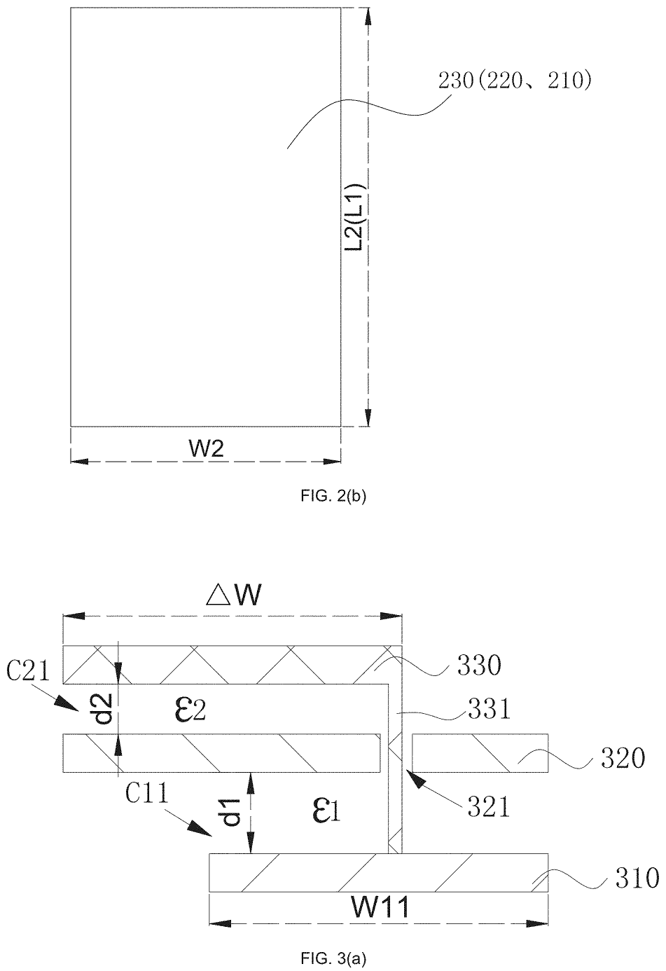

The embodiment of the present invention provides a bootstrap capacitor of a gate driver on array (GOA) circuit. Please refer to FIG. 2(a) and FIG. 2(b). The bootstrap capacitor includes a first branch capacitor C1 and a second branch capacitor C2. The first branch capacitor C1 is in the same position on the display panel as the bootstrap capacitor of the prior art, and the second branch capacitor C2 is located above the first branch capacitor C1. Here, the second branch capacitor C2 is located directly above the first branch capacitor C1 but the invention is not limited thereto. In other embodiments of the present invention, the second branch capacitor may also be located obliquely above the first branch capacitor.

In the present embodiment, the second branch capacitor C2 is connected in parallel with the first branch capacitor C1. Since the two capacitors are connected in parallel, and the calculation formula is: Ctotal=C1+C2, that is, the total capacitance after the first branch capacitor C1 and the second branch capacitor C2 are connected in parallel is the sum of the capacitance of the first branch capacitor C1 and the capacitance of the second branch capacitors C2, so that the width of the bootstrap capacitor is reduced. The capacitance required for the bootstrap capacitor in the GOA circuit can be achieved by the parallel connection of the first branch capacitor C1 and the second branch capacitor C2. Meanwhile, each of the capacitance of the first branch capacitor C1 and the capacitance of the second branch capacitor C2 is smaller than the capacitance required for the bootstrap capacitor in the GOA circuit.

In this embodiment, a projection of the second branch capacitor C2 at least partially overlaps a projection of the first branch capacitor C1 in a horizontal plane to reduce a width of the bootstrap capacitor. In this embodiment, the projection of the second branch capacitor C2 in the horizontal plane is less than or equal to the projection of the first branch capacitor C1 in the horizontal plane, and the projection of the second branch capacitor C2 in the horizontal plane falls completely within a range of the projection of the first branch capacitor C1 in the horizontal plane. Here, the projection of the second branch capacitor C2 in the horizontal plane completely overlaps with the projection of the first branch capacitor C1 in the horizontal plane. In this embodiment, since the first branch capacitor C1 is at the same position as the bootstrap capacitor in the prior art, the partial capacitance of the bootstrap capacitor is shared by the second branch capacitor C2, and the capacitance of the first branch capacitor C1 is less than the capacitance of the bootstrap capacitor in the GOA circuit of the prior art. Thus, the width occupied by the first branch capacitor C1 in the display panel can be reduced. Since the projection of the second branch capacitor C2 in the horizontal plane falls completely within a range of the projection of the first branch capacitor C1 in the horizontal plane, the width occupied by the bootstrap capacitor in the display panel can also be reduced, thereby being advantageous for the achievement of a narrow frame of the liquid crystal display panel with the GOA circuit.

In this embodiment, the first branch capacitor C1 comprises a first electrode plate 210 and a second electrode plate 220, and the second branch capacitor C2 comprises the second electrode plate 220 and a third electrode plate 230. Namely, the first branch capacitor C1 and the second branch capacitor C2 share the second electrode plate 220, and a projection of the first electrode plate 210 on the second electrode plate 220 at least partially overlaps a projection of the third electrode plate 230 on the second electrode plate 220 to reduce the width of the bootstrap capacitor. Here, lengths and widths of the first electrode plate 210, the second electrode plate 220 and the third electrode plate 230 are all equal, and the first electrode plate, the second electrode plate and the third electrode plate are completely disposed opposite to one another. Namely, projections of the three electrode plates in the horizontal plane completely overlap, thereby significantly reduce the width occupied by the bootstrap capacitor in the display panel.

Please refer to FIG. 2(a) and FIG. 2(b). How the technical solution of the embodiment reduces the width of the bootstrap capacitor in order to achieve the same capacitance as the prior art is specifically described:

Cₜₒₜₐₗ=Cₚᵣₑₛₑₙₜ;

and Cₜₒₜₐₗ=C1+C2;

substituting parameters in FIG. 2(a) and FIG. 2(b) to obtain:

$$C 1 = \frac{ɛ 1 L 1 W 1}{4 K π d 1} ; C 2 = \frac{ɛ 2 L 2 W 2}{4 K π d 2} ;$$

substituting the calculation formula of the capacitor of the prior art and the calculation formulas of C1 and C2 of the present embodiment to obtain:

$$\frac{ɛ 0 L 0 W 0}{4 K π d 0} = \frac{ɛ 1 L 1 W 1}{4 K π d 1} + \frac{ɛ 2 L 2 W 2}{4 K π d 2} ;$$

since the first branch capacitor C1 is at the same position as the bootstrap capacitor in the prior art, thus, ε1 is the same as ε0, and d1 is the same as d0; since the lengths and the widths of the first electrode plate 210, the second electrode plate 220 and the third electrode plate 230 in the first branch capacitor C1 are all equal, thus L1 is the same as L2, and W1 is the same as W2, and meanwhile in general, similar as the bootstrap capacitor in the prior art, in order to minimize the width of the bootstrap capacitor, the length of the bootstrap capacitor is designed to be as long as possible, and then L1 and L2 are generally designed to be the same as L0, and these parameters are substituted into the foregoing equation for calculation to obtain:

$$\frac{W 0}{W 1} = 1 + \frac{ɛ 2 d 0}{ɛ 0 d 2} ;$$

In the foregoing formula, since

$$\frac{ɛ 2 d 0}{ɛ 0 d 2}$$

is necessarily greater than 0, and then the value of

$$\frac{W 0}{W 1}$$

must be greater than 1, that is, W0 is necessarily greater than W1. W0 is the width occupied by the bootstrap capacitor of the prior art, and W1 is the width occupied by the bootstrap capacitor of this embodiment. Accordingly, compared with the prior art, the width occupied by the bootstrap capacitor in the display panel can be reduced, thereby facilitating the achievement of the narrow frame of the display panel with the GOA circuit. Meanwhile, in this embodiment, since the lengths and the widths of the first electrode plate 210, the second electrode plate 220 and the third electrode plate 230 are all equal, the width of the bootstrap capacitor can be reduced as possible, and the frame width of the display panel can be minimized.

In order to realize the parallel connection of the first branch capacitor C1 and the second branch capacitor C2, in this embodiment, referring to FIG. 2(a), the bootstrap capacitor further includes a connection electrode 231, and a material of the connection electrode 231 is the same as a material of the third electrode plate 230. The connection electrode 231 is respectively connected to the first electrode plate 210 and the third electrode plate 230 to realize the parallel connection of the first branch capacitor C1 and the second branch capacitor C2. In order to reduce the width of the bootstrap capacitor by reducing the connection electrode 231 configured to the outside, in this embodiment, the second electrode plate 220 is provided with a via hole 221, and the connection electrode 231 is electrically connected to the first electrode plate 210 and the third electrode plate 230 through the via hole 221, respectively. In this embodiment, the via hole 221 is larger than the size of the connection electrode 231. A gap exists between the hole wall of the via hole 221 and the connection electrode 231 to prevent the second electrode plate 220 from being electrically connected or short-circuited with the connection electrode 231.

Besides, in this embodiment, a gate insulating layer is disposed between the first electrode plate 210 and the second electrode plate 220, and a material of the gate insulating layer may be a silicon nitride material for illustration. A second insulating layer is disposed between the second electrode plate 220 and the third electrode plate 230, and a material of the second insulating layer may be a silicon nitride material, an organic insulating layer or an inorganic insulating layer for illustrations.

In this embodiment, a material of the first electrode plate 210 may be a single metal material or a metal alloy. For instance, the material of the first electrode plate 210 may be Al, Mo or an alloy of Mo and Al. A material of the second electrode plate 220 may be a single metal material or a metal alloy, such as a material of Mo/Al/Mo. A material of the third electrode plate 230 is indium tin oxide (ITO) and a material of the connection electrode 231 is also ITO.

The embodiment of the present invention further provides a gate driver on array (GOA) circuit. The GOA circuit comprises a plurality of units coupled in cascade. The unit of each stage comprises the aforesaid bootstrap capacitor. Besides, the unit of each stage of the GOA circuit further comprises a pull-up control circuit, a pull-up circuit, a pull-down holding circuit, a pull-down circuit and a stage transfer circuit.

The embodiment of the present invention further provides a display panel. The display panel comprises the foregoing GOA circuit. The display panel includes a substrate, a first metal layer, a second metal layer and a third metal layer in order from bottom to top. The first metal layer forms the first electrode plate 210, the gate. The second metal layer forms the second electrode plate 220, the source and the drain. The third metal layer forms the third electrode plate 230 and the pixel electrode. In this embodiment, the display panel is a thin film transistor liquid crystal display panel, and the thin film transistor in the thin film transistor liquid crystal display panel may be an a-Si type thin film transistor, or may be an indium gallium zinc oxide (IGZO) type thin film transistor.

### The Second Embodiment

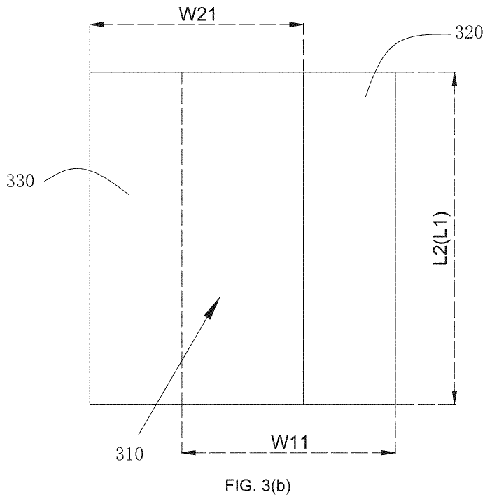

FIG. 3(a) is a cross-sectional diagram of a bootstrap capacitor of a GOA circuit according to the second embodiment of the present invention. The structure of FIG. 3(a) is the same as the structure of FIG. 2(a), and therefore the same component symbols represent the same components. The main difference between this embodiment and the first embodiment is the structure of the first branch capacitor and the second branch capacitor.

Please refer to FIG. 3(a) and FIG. 3(b). The bootstrap capacitor includes a first branch capacitor C11 and a second branch capacitor C21. The second branch capacitor C21 is located above the first branch capacitor C11. Here, the second branch capacitor C21 is located obliquely above the first branch capacitor C11, and specifically, is located obliquely above at the left side. Certainly, in other embodiments of the present invention, the second branch capacitor may be located obliquely above the first branch capacitor at the right side. In this embodiment, the second branch capacitor C21 is connected in parallel with the first branch capacitor C11, and a projection of the second branch capacitor C21 at least partially overlaps a projection of the first branch capacitor C11 in a horizontal plane to reduce a width of the bootstrap capacitor.

In this embodiment, the first branch capacitor C11 comprises a first electrode plate 310 and a second electrode plate 320, and the second branch capacitor C21 comprises the second electrode plate 320 and a third electrode plate 330. The width of the second electrode plate 320 is greater than the width of the first electrode plate 310 and the width of the third electrode plate 330. In this embodiment, a left end of the second electrode plate 320 is aligned with a left end of the third electrode plate 330, and a right end of the second electrode plate 320 is aligned with a right end of the first electrode plate 310. In this embodiment, a projection of the first electrode plate 310 on the second electrode plate 320 at least partially overlaps a projection of the third electrode plate 330 on the second electrode plate 320.

For reducing the width of the bootstrap capacitor, in this embodiment, a distance between the first electrode plate 310 and the second electrode plate 320 is d1, and a length of an overlapping region of the first electrode plate 310 and the second electrode plate 320 is L1, and a dielectric constant of the first branch capacitor C11 is ε1, and a distance between the third electrode plate 330 and the second electrode plate 320 is d2, and a length of an overlapping region of the third electrode plate 330 and the second electrode plate 320 is L2, and a dielectric constant of the second branch capacitor C21 is ε2, and then:

$$\frac{ɛ 1 L 1}{d 1} \leq \frac{ɛ 2 L 2}{d 2} .$$

Since the foregoing formula is satisfied, and the projection of the first electrode plate 310 on the second electrode plate 320 at least partially overlaps the projection of the third electrode plate 330 on the second electrode plate 320 to achieve the reduction of the width occupied by the bootstrap capacitor in the display panel.

Please refer to FIG. 3(a) and FIG. 3(b). How the technical solution of this embodiment reduces the width of the bootstrap capacitor is specifically described. Assuming that the width of the first branch capacitor C11 is reduced by ΔW in comparison with the bootstrap capacitor the prior art, for compensating the reduced capacitance of the first branch capacitor C11, the width of the second branch capacitor C21 is assumed to be ΔW, and the increased capacitance of the second branch capacitor C21 to compensate the decreased capacitance of the first branch capacitor C11 is:

$$C 21 = \frac{ɛ 2 L 2 Δ W}{4 K π d 2} ;$$

$$since \frac{ɛ 1 L 1}{d 1} \leq \frac{ɛ 2 L 2}{d 2} ;$$

then:

$$C 21 = \frac{ɛ 2 L 2 Δ W}{4 K π d 2} \geq \frac{ɛ 1 L 1 Δ W}{4 K π d 1} ;$$

moreover, since the projection of the first electrode plate 310 on the second electrode plate 320 at least partially overlaps the projection of the third electrode plate 330 on the second electrode plate 320, and then:

$$C 21 = \frac{ɛ 2 L 2 Δ W}{4 K π d 2} > \frac{ɛ 1 L 1 Δ W}{4 K π d 1} ;$$

thus, the capacitance of the second branch capacitor C21 is greater than the capacitance of the first branch capacitor C11, and then the width of the second branch electrode can be set to be less than ΔW, and then the width of the bootstrap capacitor will be less than W11+ΔW. The width occupied by the bootstrap capacitor can be reduced to reduce the width of the side frame.

Generally, there is a plurality of bootstrap capacitors on the display panel. In order to minimize the width occupied by the bootstrap capacitor in the display panel, and for the convenience of the process, the length of the bootstrap capacitor is generally designed to be as long as possible. Namely, the length of the bootstrap capacitor is typically designed to the maximum length. Thus, the lengths of the first branch capacitor C11 and the second branch capacitor C21 are generally designed to be the same. Accordingly, the foregoing formula can be further transformed into:

$$\frac{ɛ1}{d 1} \leq \frac{ɛ2}{d 2} .$$

Besides, in this embodiment, for realizing the parallel connection of the first branch capacitor C11 and the second branch capacitor C21, the overlapping portion of the projection of the third electrode plate 330 on the second electrode plate 320 and the projection of the first electrode plate 310 on the second electrode plate 320 is connected to the connection electrode 331. Here, the connection electrode 331 is configured at the right side of the third electrode plate 330. Two ends of the connection electrode 331 are electrically connected to the third electrode plate 330 and the first electrode plate 310, respectively. In this embodiment, the second electrode plate 320 is provided with a via hole 321, and the connection electrode 331 is electrically connected to the first electrode plate 310 through the via hole 321 from the third electrode plate 330. A gap exists between the connection electrode 331 and the hole wall of the via hole 321.

Significantly, each of the embodiments in the specification is described in a progressive manner, and each embodiment focuses on the differences from other embodiments, and the same or similar parts among the various embodiments can be referred to one another. For the embodiment of the device, it is basically similar with the embodiment of method, so the description is simpler, and the related parts can be referred to the description of the embodiment of method.

Above are embodiments of the present invention, which does not limit the scope of the present invention. Any equivalent amendments within the spirit and principles of the embodiment described above should be covered by the protected scope of the invention.

What is claimed is:

1. A bootstrap capacitor of a gate driver on array (GOA) circuit, comprising:
a first branch capacitor; and
a second branch capacitor, located above the first branch capacitor, wherein the second branch capacitor is connected in parallel with the first branch capacitor, and a projection of the second branch capacitor at least partially overlaps a projection of the first branch capacitor in a horizontal plane to reduce a width of the bootstrap capacitor.

2. The bootstrap capacitor of the GOA circuit according to claim 1, wherein the projection of the second branch capacitor in the horizontal plane is less than or equal to the projection of the first branch capacitor in the horizontal plane, and the projection of the second branch capacitor in the horizontal plane falls completely within a range of the projection of the first branch capacitor in the horizontal plane.

3. The bootstrap capacitor of the GOA circuit according to claim 1, wherein the first branch capacitor comprises a first electrode plate and a second electrode plate, and the second branch capacitor comprises the second electrode plate and a third electrode plate, and a projection of the first electrode plate on the second electrode plate at least partially overlaps a projection of the third electrode plate on the second electrode plate.

4. The bootstrap capacitor of the GOA circuit according to claim 3, wherein lengths and widths of the first electrode plate, the second electrode plate and the third electrode plate are all equal, and the first electrode plate, the second electrode plate and the third electrode plate are completely disposed opposite to one another.

5. The bootstrap capacitor of the GOA circuit according to claim 3, wherein a distance between the first electrode plate and the second electrode plate is d1, and a length of an overlapping region of the first electrode plate and the second electrode plate is L1, and a dielectric constant of the first branch capacitor is ε1, and a distance between the third electrode plate and the second electrode plate is d2, and a length of an overlapping region of the third electrode plate and the second electrode plate is L2, and a dielectric constant of the second branch capacitor is ε2, and then:
$$\frac{ɛ 1 L 1}{d 1} \leq \frac{ɛ 2 L 2}{d 2} .$$

6. The bootstrap capacitor of the GOA circuit according to claim 3, further comprising a connection electrode, wherein the connection electrode is electrically connected to the first electrode plate and the third electrode plate, respectively, to achieve a parallel connection of the first branch capacitor and the second branch capacitor.

7. The bootstrap capacitor of the GOA circuit according to claim 4, further comprising a connection electrode, wherein the connection electrode is electrically connected to the first electrode plate and the third electrode plate, respectively, to achieve a parallel connection of the first branch capacitor and the second branch capacitor.

8. The bootstrap capacitor of the GOA circuit according to claim 5, further comprising a connection electrode, wherein the connection electrode is electrically connected to the first electrode plate and the third electrode plate, respectively, to achieve a parallel connection of the first branch capacitor and the second branch capacitor.

9. The bootstrap capacitor of the GOA circuit according to claim 6, wherein an overlapping portion of the projection of the third electrode plate on the second electrode plate and the projection of the first electrode plate on the second electrode plate is connected to the connection electrode, and a via hole is disposed on the second electrode plate, and the connection electrode is electrically connected to the first electrode plate and the third electrode plate through the via hole.

10. The bootstrap capacitor of the GOA circuit according to claim 3, wherein a gate insulating layer is disposed between the first electrode plate and the second electrode plate, and a second insulating layer is disposed between the second electrode plate and the third electrode plate.

11. A gate driver on array (GOA) circuit, comprising a bootstrap capacitor, wherein the bootstrap capacitor comprises:
a first branch capacitor; and
a second branch capacitor, located above the first branch capacitor, wherein the second branch capacitor is connected in parallel with the first branch capacitor, and a projection of the second branch capacitor at least partially overlaps a projection of the first branch capacitor in a horizontal plane to reduce a width of the bootstrap capacitor.

12. The GOA circuit according to claim 11, wherein the projection of the second branch capacitor in the horizontal plane is less than or equal to the projection of the first branch capacitor in the horizontal plane, and the projection of the second branch capacitor in the horizontal plane falls completely within a range of the projection of the first branch capacitor in the horizontal plane.

13. The GOA circuit according to claim 11, wherein the first branch capacitor comprises a first electrode plate and a second electrode plate, and the second branch capacitor comprises the second electrode plate and a third electrode plate, and a projection of the first electrode plate on the second electrode plate at least partially overlaps a projection of the third electrode plate on the second electrode plate.

14. The GOA circuit according to claim 13, wherein lengths and widths of the first electrode plate, the second electrode plate and the third electrode plate are all equal, and the first electrode plate, the second electrode plate and the third electrode plate are completely disposed opposite to one another.

15. The GOA circuit according to claim 13, wherein a distance between the first electrode plate and the second electrode plate is d1, and a length of an overlapping region of the first electrode plate and the second electrode plate is L1, and a dielectric constant of the first branch capacitor is ε1, and a distance between the third electrode plate and the second electrode plate is d2, and a length of an overlapping region of the third electrode plate and the second electrode plate is L2, and a dielectric constant of the second branch capacitor is ε2, and then:
$$\frac{ɛ 1 L 1}{d 1} \leq \frac{ɛ 2 L 2}{d 2} .$$

16. The GOA circuit according to claim 13, wherein the bootstrap capacitor further comprises a connection electrode, wherein the connection electrode is electrically connected to the first electrode plate and the third electrode plate, respectively, to achieve a parallel connection of the first branch capacitor and the second branch capacitor.

17. The GOA circuit according to claim 16, wherein an overlapping portion of the projection of the third electrode plate on the second electrode plate and the projection of the first electrode plate on the second electrode plate is connected to the connection electrode, and a via hole is disposed on the second electrode plate, and the connection electrode is electrically connected to the first electrode plate and the third electrode plate through the via hole.

18. The GOA circuit according to claim 13, wherein a gate insulating layer is disposed between the first electrode plate and the second electrode plate, and a second insulating layer is disposed between the second electrode plate and the third electrode plate.

19. A display panel, comprising the GOA circuit according to claim 11.
